(19) United States
(12) Patent Application Publication
(10) Pub. No.: US 2025/0382949 A1
(43) Pub. Date: Dec. 18, 2025

(54) Photo Self-Actuated Structure Enabled By Interfacial Activated Negative Thermal Expansion

(71) Applicants: The Regents of The University of Michigan, Ann Arbor, MI (US); Saudi Aramco Technologies Company, Dhahran (SA)

(72) Inventors: Young Geun Park, Ann Arbor, MI (US); Somin Eunice Lee, Ann Arbor, MI (US); Ammar Alahmed, Dhahran (SA); Mourad Younes, Dhahran (SA); Aqil Jamal, Dhahran (SA)

(73) Assignees: The Regents of The University of Michigan, Ann Arbor, MI (US); Saudi Aramco Technologies Company, Dhahran (SA)

(21) Appl. No.: 19/233,392

(22) Filed: Jun. 10, 2025

Related U.S. Application Data
(60) Provisional application No. 63/659,568, filed on Jun. 13, 2024.

(51) Int. Cl. F03G 7/06; B25J 9/10; B32B 9/04; B32B 25/20; E06B 9/24

(52) U.S. Cl. CPC F03G 7/0614; B25J 9/1085; B32B 9/041; B32B 9/045; B32B 25/20; E06B 9/24; F03G 7/06114; B32B 2250/03; B32B 2307/202; B32B 2307/30; B32B 2307/412; B32B 2307/7376; B32B 2311/24; E06B 2009/2417

(57) ABSTRACT

The simultaneous enhancement of photo-thermal actuation, optical flexibility, and structural stability of a multi-layered polymeric structure made possible by the integration of an interfacial graphene nanogap layer (iGL) is presented. The present disclosure provides a geometric arrangement of a graphene layer at the interface between a conducting metal layer and optically transparent elastomer layer causing large strain mismatch owing to negative thermal expansion. As a result, rapid and significantly enhanced photo-actuation of the pore membrane/micro shutter structure is achieved, which is 100% larger and faster than conventional cases between 25° C. and 120° C. Furthermore, the iGL enables timely, structurally consistent, and durable actuation performances independent of the environmental parameters such as working phases or light illumination angles. Given these features, an actuator employing the iGL provides rapid and sensitive stimulus operation of light control.

### CROSS-REFERENCE TO RELATED APPLICATIONS

This application claims the benefit of U.S. Provisional Application No. 63/659,568 filed on Jun. 13, 2024. The entire disclosure of the above application is incorporated herein by reference.

### FIELD

The present disclosure relates to self-actuated materials and structures including self-actuated materials.

### BACKGROUND

As global energy demand and climate change present critical challenges, there is an urgent need for novel and smart materials to foster the development of sustainable technologies. Smart walls for example, are emerging building enclosures that enable self-regulation of solar energy and moisture, allowing to increase the comfort while reducing the energy needs. In another example, smart membranes that enable selective gas permeation improve fluid flow fluid actuation technologies. To this end, smart materials, such as self-activated materials, have shown great promise in a variety of applications in smart walls, sustainable energy and environmental systems (e.g., energy-efficient windows), smart motors and oscillators, smart membranes, smart robots, and biomedical devices.

Self-activated materials are a distinctive group of materials that support complex and intelligent systems and activities. In general, these materials change their structure and performance in response to external stimuli due to their bilayer interface structure. The essential steps in the self-activation process include perceiving or capturing the environmental stimulus, transmitting the stimulus to the interface of the bilayer structure, and asymmetrically releasing the energy at the interface. In the presence of surface stresses, misfit strains, residual strains, thermal stresses, swelling and shrinkage, and differential growth, the stimulus induces an asymmetric release of potential energy at the bilayer interface. The interface of self-activated smart materials mainly suffers from large stresses caused by excessive expansion and contraction of the actuation layer, while the symmetric heat transfer over the interface results in limited actuation. These fundamental issues of strain and heat transfer at the interface of two materials cannot be resolved unless the structural stress and heat transfer are addressed simultaneously at nanoscale. Accordingly, extensive efforts have been made in producing micro-and nano-thin layers that encompass self-activation capabilities under a uniform environmental change by controlling the interfacial stress in the self-bending material. However, current self-actuated bending materials have a limited range of structural changes, low sensitivity, and poor strength.

Some self-activated materials may be photo-actuated or change structure in response to light. One example of photo-actuated material that has drawn interest includes a single-walled carbon nanotube (SWNT) between polymer bilayers. Such material provides a wavelength-specific response that results in a relatively large material deflection due to the optical absorbance of SWNTs. However, current self-activated bending materials exhibit low optical transmission and poor mechanical characteristics. Moreover, these materials are difficult to manufacture due to limited fabrication steps available for SWNTs. In particular, SWNTs are generally integrated into the bilayer structure with low uniformity which results in limited light activation and mechanical performance of the self-activated material.

The performance of known photo sensitive self-actuation structures are highly dependent on the direction of the incident light. In particular, the directional change of the incident light caused a dimensional change of the structure itself, (i.e., the “self-shading effect”), is a source of inconsistency in photosensitive self-actuation structures.

Accordingly, it is advantageous to develop a self-activated material that is responsive to light, has minimized self-shading during operation, is easy to manufacture, is durable, and has strong mechanical characteristics. It is also advantageous to incorporate such material into a variety of light-responsive applications such as smart shutters, smart motors and oscillators, smart robots, smart membranes and/or smart biomedical devices.

This section provides background information related to the present disclosure which is not necessarily prior art.

### SUMMARY

This section provides a general summary of the disclosure, and is not a comprehensive disclosure of its full scope or all of its features.

In one aspect, a self-activated structure (also referred to herein as the “bending structure) includes a base layer, an interface layer, and a temperature sensing layer. The interface layer is disposed on the base layer and the temperature sensing layer is disposed on the interface layer. The base layer includes a transparent elastomer. The interface layer includes graphene. The temperature sensing layer includes a metal. The self-activated structure alters its shape reversibly as a function of light.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A(i)-1A(iii), 1B, and 1C are schematics depicting a self-activated structure in accordance with this disclosure;

FIGS. 2A(i)-2A(ii) and 2(B)(i)-2B(ii) are diagrams depicting a self-activated structure in a deactivated position (FIGS. 2A(i)-2A(ii)) and activated position (FIGS. 2B(i)-2B(ii)) in accordance with this disclosure;

FIGS. 2C-2D and 2E(i)-2E(iv) depict models to calculate a curvature of a self-activated structure in accordance with this disclosure;

FIGS. 3A(i)-3A(ii) and 3B(i)-3B(ii) are diagrams depicting an actuator including a self-activated structure in accordance with this disclosure;

FIG. 4 is a schematic of a building structure including the actuator of FIGS. 3A(i)-3A(ii) and 3B(i)-3B(ii) in accordance with this disclosure;

FIGS. 5A-5E are schematics of other actuators including a self-activated structure of FIGS. 3A(i)-3A(ii) and 3B(i)-3B(ii) in accordance with this disclosure;

FIG. 6 is a schematic of another actuator including a self-activated structure for a robot in accordance with this disclosure;

FIG. 7 is a flowchart depicting a method of actuating a self-activated structure in accordance with this disclosure;

FIGS. 8A-8G are schematics depicting a method of fabricating a self-activated structure in accordance with this disclosure;

FIGS. 9A(i)-9A(ii) and 9B(i)-9B(ii) are FEA models of an experimental self-activated structure (FIGS. 9A(i)-9A(ii)) and a control structure (FIGS. 9B(i)-9B(ii)) in accordance with this disclosure;

FIG. 9C is a diagram showing bending angle as a function of temperature of the self-activated structure and control structure of FIGS. 9A(i)-9A(ii) and 9B(i)-9B(ii);

FIG. 9D is a diagram showing bending angle as a function of interface layer thickness and temperature of the self-activated structure and control structure of FIGS. 9A(i)-9A(ii) and 9B(i)-9B(ii);

FIG. 9E is a diagram showing the bending angle as a function of base layer and temperature sensing layer thickness and temperature of the self-activated structure and control structure of FIGS. 9A(i)-9A(ii) and 9B(i)-9B(ii);

FIGS. 10A(i)-10A(ii) are schematics of an experimental setup of a self-activated structure fabricated via the method depicted in FIGS. 8A-8G (FIG. 10A(i)) and a control structure (FIG. 10A(ii));

FIG. 10B is a schematic of the self-activated structure and control structure of FIGS. 10A(i)-10A(ii) after light illumination;

FIG. 10C is a diagram showing the bending angle of the self-activated structure and control structure of FIGS. 10A(i)-10A(ii) as a function of time after light illumination;

FIGS. 10D-10E are diagrams showing bending angle of the self-activated structure and control structure of FIGS. 10A(i)-10A(ii) as a function of light intensity; and

FIGS. 11A-11C are diagrams depicting structural change as a function of light intensity for an actuator including a self-activated structure in accordance with this disclosure.

Corresponding reference numerals indicate corresponding parts throughout the several views of the drawings.

### DETAILED DESCRIPTION

Example embodiments will now be described more fully with reference to the accompanying drawings.

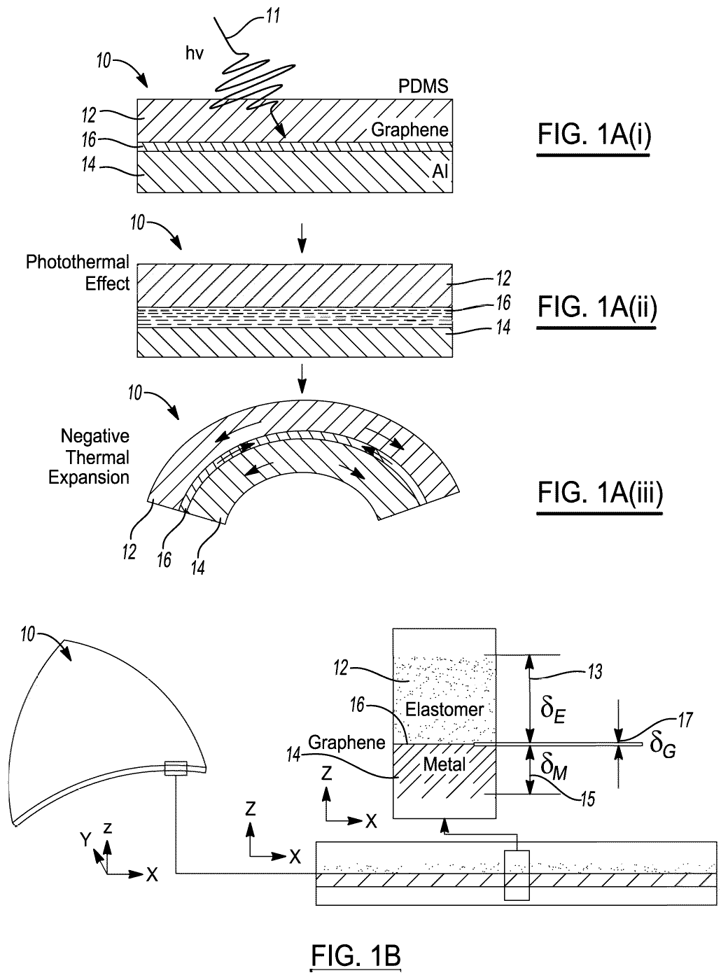

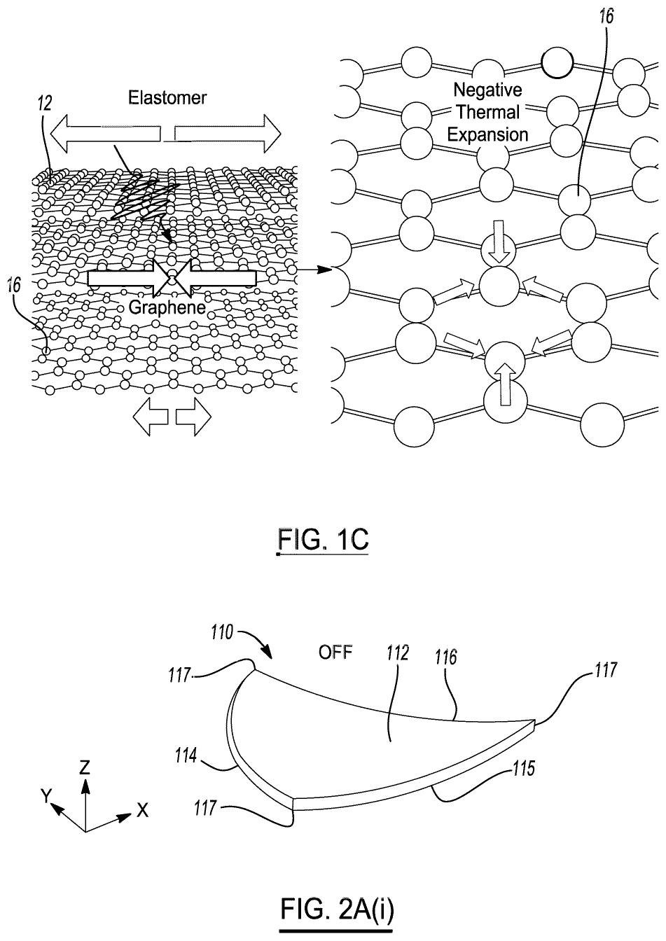

FIGS. 1A(i)-1A(iii), 1B, and 1C depict a self-activated structure 10 (also referred to as the “bending structure 10”) in accordance with this disclosure. The self-activated structure 10 is configured to reversibly alter its shape in response to an external stimulus 11. Specifically, the self-activated structure 10 is configured to reversibly alter its shape in response to light. In other words, the self-activated structure 10 is a photo-actuated structure.

As shown in the example of FIG. 1A-1C, the external stimulus 11 is a light source. The light may be visible light (i.e., light having a wavelength that is about 380 nanometers (nm) to about 700 nm) (e.g., sunlight, incandescent light, LED light, etc.) and/or infrared light (i.e., light having a wavelength that is about 760 nm to about 1 mm) (e.g., IR-A light, IR-B light, and/or IR-C light).

The light source (i.e., the external stimulus 11) is directed to the self-activated structure 10. For example, the light source may be artificial light, such as a light beam that is directed to the self-activated structure 10. Alternately, the light source may be ambient sunlight. When the light source is artificial light, the beam may directed to the self-activated structure at an intensity of about 100 W/m² to about 1000 W/m² (e.g. an intensity that is greater than or equal to about 150 W/m², optionally greater than or equal to about 200 W/m², optionally greater than or equal to about 250 W/m², optionally greater than or equal to about 300 W/m², optionally greater than or equal to about 400 W/m², optionally greater than or equal to about 500 W/m², optionally greater than or equal to about 600 W/m², optionally greater than or equal to about 700 W/m², optionally greater than or equal to about 800 W/m², or optionally greater than or equal to about 900 W/m². When the light source is sunlight, the intensity is much higher, such as greater than or equal to about 1000 mW/m² (e.g., greater than or equal about 1000 W/m², optionally greater than or equal to about 2000 W/m², optionally greater than or equal to about 3000 W/m², optionally greater than or equal to about 4000 W/m², optionally greater than or equal to about 5000 W/m², optionally greater than or equal to about 6000 W/m², optionally greater than or equal to about 7000 W/m², optionally greater than or equal to about 8000 W/m², or optionally greater than or equal to about 9000 W/m²).

The self-activated structure 10 is comprised of a base layer 12 and a temperature sensing layer 14. In one example embodiment, the base layer 12 is an elastomer. Specifically, the base layer 12 is a transparent elastomer. The base layer 12 may include an organic polymer. For example, the base layer 12 is selected from the group consisting of: polydimethylsiloxane (PDMS), polyaniline, polypyrrole (PPy), polythiophene (PT), polystyrene (PS), polyphenylene-vinylene (PPV), polyphenylenesulfide (PPS), polyacetylene (PA), polyfluorene (PFO), co-polymers thereof, and combinations thereof.

The temperature sensing layer 14 is a conductive metal. The temperature sensing layer 14 is selected from the group consisting of: aluminum, gold silver, copper, alloys thereof, and combinations thereof. Other types of transparent elastomers and other types of conducting metals are contemplated by this disclosure.

As shown in FIG. 1B, the base layer 12 has a first thickness 13 (δ_{E}) that is greater than or equal to about 100 nanometers (nm) to less than or equal to about 10 micrometers (μm). More narrowly, the first thickness 13 is greater than or equal to about 250 nm to about 5 μm. In one example embodiment, the first thickness 13 of the base layer 12 is about 750 nm. In another example embodiment, the first thickness 13 of the base layer 12 is about 5 μm.

The temperature sensing layer 14 has a second thickness 15 (δ_{M}) that is greater than or equal to about 5 nm to less than or equal to about 5 μm. More narrowly, the second thickness 15 is greater than or equal to about 100 nm to less than or equal to about 1 μm. In one example embodiment, the second thickness 15 of the temperature sensing layer 14 is about 500 nm.

A ratio of the first thickness 13 of the base layer 12 and the second thickness 15 of the temperature sensing layer 14 (δ_{E}/δ_{M}) is greater than or equal to 0.1 to less than or equal to about 50, or more narrowly, greater than or equal to 1 to less than or equal to 10. In one example embodiment, the ratio is about 1.5. In another example embodiment, the ratio is about 10.

Referring back to FIG. 1A, significantly enhanced self-actuation of the self-activated structure 10 is achieved by integrating anisotropic van der Waals thermal conduction and asymmetric expansion at an interface between the base layer 12 and the temperature sensing layer 14. A difference in the thermal expansion coefficient (α) and the heat transfer coefficient (K) between the base layer 12 and the temperature sensing layer 14 leads to asymmetric actuation of the self-activated structure 10 and results in interfacial strain. An interface layer 16 disposed between the base layer 12 and the temperature sensing layer 14 increases or enhances this interfacial strain. In the example embodiment of FIG. 1, the interface layer 16 is disposed directly on the base layer 12 and the temperature sensing layer 14 is disposed directly on the interface layer 16. It is contemplated that additional layers may be positioned in between the temperature sensing layer 14 and the interface layer 16, such as to improve adhesion between the interface layer 16 and the temperature sensing layer 14.

The interface layer 16 is about 100 times thinner than the base layer 12 and the temperature sensing layer 14. As shown in FIG. 1B, a third thickness 17 of the interface layer 16 (δ_{G}) is determined by a ratio of the thickness of the base layer 12 (δ_{E}) and the interface layer 16 (δ_{G}) (e.g., (δ_{G}/δ_{E})) and/or a ratio of the thickness of the base layer 12 and the temperature sensing layer 14 (δ_{M}) (e.g., (δ_{E}/δ_{M})). The third thickness 17 is greater than 0 nm to less than or equal to about 10 nm. More narrowly, the third thickness 17 is greater than or equal to about 2 nm to less than or equal to about 5 nm. In one example embodiment, the third thickness 17 of the interface layer 16 is about 5 nm. In one example embodiment, the ratio of the thickness of the interface layer 16 and the base layer 12 is about 0.001.

The interface layer 16 is configured to enable photo-actuation of the self-activated structure 10 by converting photothermal energy into mechanical motion. In other words, when activated via light 11 (e.g., by directing a beam of light towards the self-activated structure 10), the interface layer 16 utilizes photothermal energy to reversibly alter the shape of the self-activated structure 10. As shown in FIG. 1A, incident light 11 passes through the transparent base layer 12. At least a portion of the light 11 is absorbed by the temperature sensing layer 14. As shown in FIG. 1B, when the light 11 reaches the temperature sensing layer 14 it is converted to thermal energy via joule heating, thus inducing a photothermal effect. The temperature sensing layer 14 transfers heat to the interface layer 16 (i.e., heat is diffused through the interface layer 16). The rapid heat conduction between the temperature sensing layer 14 and interface layer 16 leads to a uniform and focused dynamic temperature profile within the interface layer 16. Consequently, as shown in FIG. 1C, negative thermal expansion of the interface layer 16 occurs due to large strain mismatch between the layers 12, 14, 16. The negative thermal expansion results in the contraction or deflection of the self-activated structure 10.

In this way, the shape of the self-activated structure 10 is reversibly altered as a function of light 11. When light is directed to the base layer 12, the self-activated structure 10 moves from a first or deactivated position (FIG. 1A(i)) (e.g., a relatively flat position) to a second or activated position (FIG. 1A(iii)) (e.g., a position exhibiting maximum contraction or deflection of the self-activated structure 10). When light is removed from the base layer 12, the self-activated structure 10 moves from the activated position (FIG. 1A(iii)) back to the deactivated position (FIG. 1A(i)). It is contemplated that the self-activated structure 10 may move through a plurality of positions in between the first and second positions. The amount of movement and relative deflection of the self-activated structure 10 is tailored by ambient temperature, light intensity, light duration, material selection and the relative thickness of each layer (e.g., the ratio of thickness of the base layer 12 and the temperature sensing layer 14 and/or the ratio of thickness of the interface layer 16 and the base layer 12).

In one example embodiment, the interface layer 16 includes graphene. The interface layer 16 may be selected from the group consisting of: graphene, graphene oxide, and combinations thereof. In other words, the interface layer 16 is an interfacial graphene nanogap layer (iGL) (also referred to as the “iGL 16”). Properties and benefits of the iGL 16 are further explained below. The iGL 16 has high thermal conductivity (˜4000 Wm⁻¹K⁻¹), which is larger than the thermal conductivity of the base layer 12 (e.g., PDMS has a thermal conductivity of about 0.16 Wm⁻¹K⁻¹) and the temperature sensing layer 14 (e.g., aluminum has a thermal conductivity of about 237 Wm⁻¹K⁻¹). The iGL 16 has a high mechanical strength that is greater than about 100 GPa.

The thermal expansion coefficient of graphene (α_{graphene}) decreases when temperature increases. In this way, when exposed to light 11, the iGL 16 leads to negative thermal expansion within the optically transparent base layer 12 and the thermal sensing layer 14. The following models are established representing a correlation between the in-plane thermal expansion coefficient α and stress coefficient σ of each of the layers of the self-activated structure 10 during photo-actuation:

$$Δ {α}_{graphene} ( < 0 ) < Δ {α}_{M} < Δ {α}_{E} \qquad ( 1 )$$

$$Δ {σ}_{graphene} ( < 0 ) < Δ {σ}_{M} < Δ {σ}_{E} \qquad ( 2 )$$

The difference in thermal expansion coefficients and stress coefficients between the iGL 16 (Δα_{graphene}, Δσ_{graphene}), the base layer 12 (Δα_{E}, Δσ_{E}), and the temperature sensing layer 14 (Δα_{M}, Δσ_{M}), results in enhanced strain at the interface layer 16. Unlike conventional materials, the thermal expansion coefficient of graphene decreases as temperature increases. The negative thermal expansion of the graphene is anisotropic.

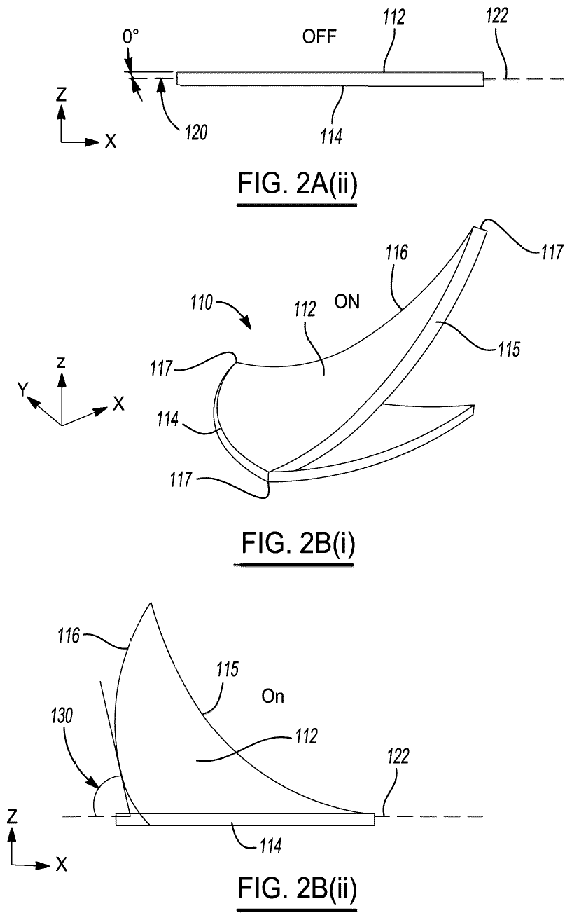

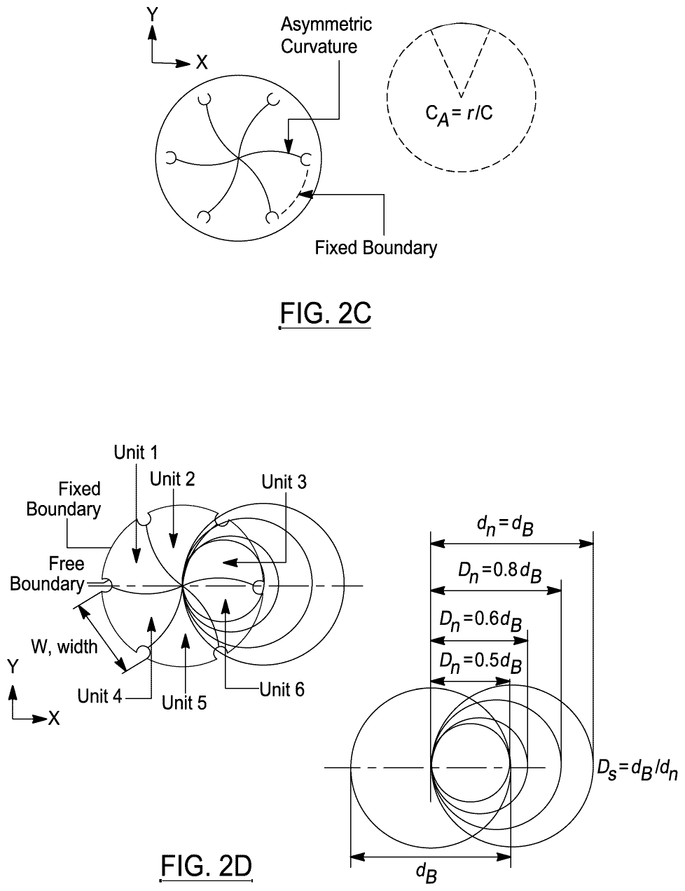

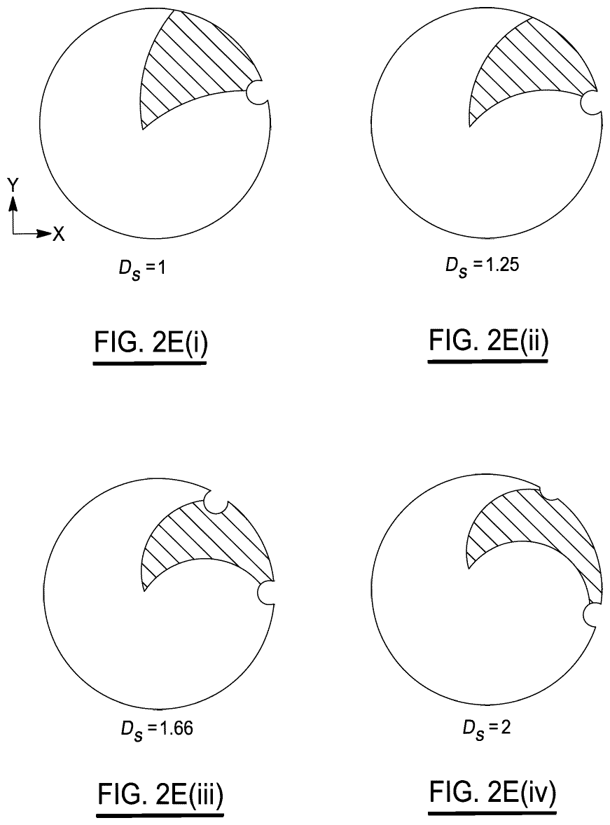

With reference to FIGS. 2A and 2B, an exemplary self-activated structure 110 (also referred to as the “bending structure 110”) includes a body 112 extending between a first or fixed end 114, a second end 115 and a third end 116. The second and third ends 115 and 116 may be movable relative to the fixed end 114 (hereafter the “movable ends 115, 116”). The first, second, and third ends 114, 115, 116 may intersect at a plurality of intersection points 117. In one example embodiment, the body 112 has a generally triangular shape, although other shapes and configurations are possible.

The self-activated structure 110 includes a base layer (see, e.g., base layer 12 of FIG. 1), a temperature sensing layer (see, e.g., temperature sensing layer 14 of FIG. 1), and an interface layer (see, e.g., interface layer 16 of FIG. 1). In a first or deactivated position (FIGS. 2A(i) and 2A(ii)) (e.g., when the self-activated structure 110 is not exposed to light), the self-activated structure 110 is relatively flat. The movable ends 115, 116 are positioned at a first angle 120 with respect to a plane 122 of the self-activated structure 110. The first angle 120 is about 0 degrees. In a second or activated position (FIGS. 2B(i) and 2B(ii)) (e.g., when light is directed to the self-activated structure 110), the movable ends 115, 116 are positioned at a second angle 130 with respect to the plane 122.

In the embodiment of FIGS. 2A and 2B, each of the first, second, and third ends 114, 115, 116 have a generally curved shape, although other shapes are contemplated. As shown in FIGS. 2C-2E, the curvature (Ds) is controlled from 1 (FIG. 2E(i)) to 2 (FIG. 2E(iv)).

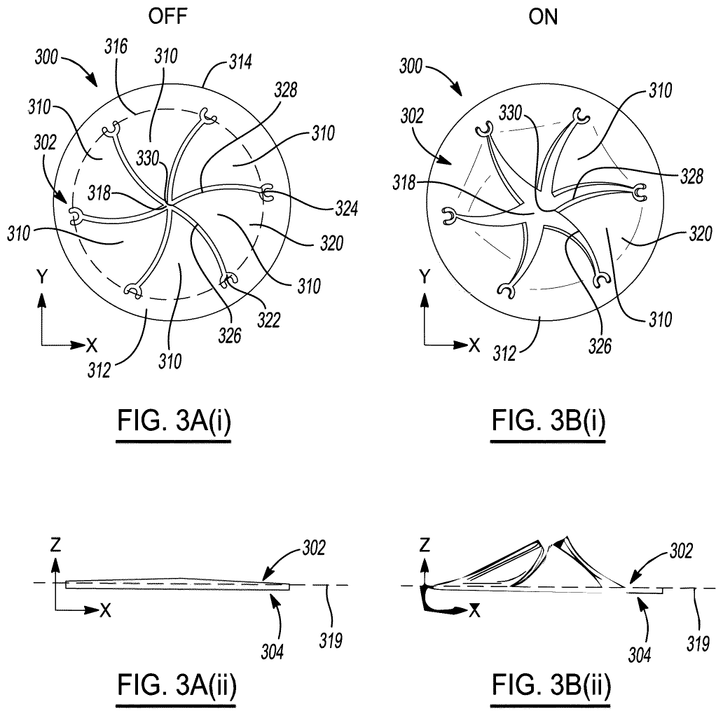

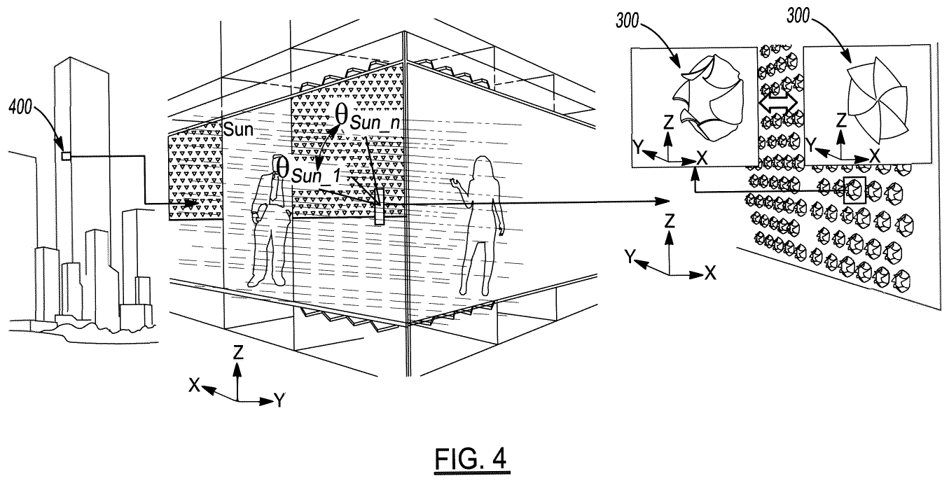

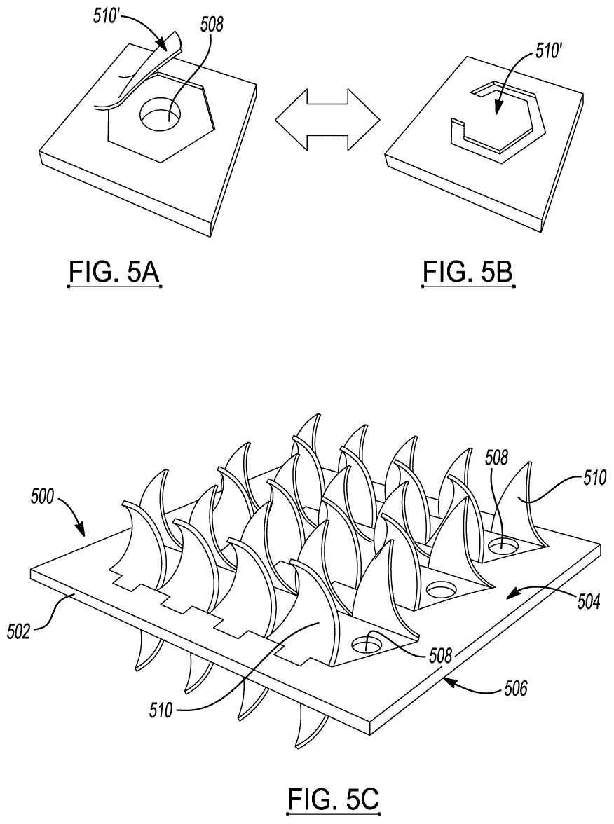

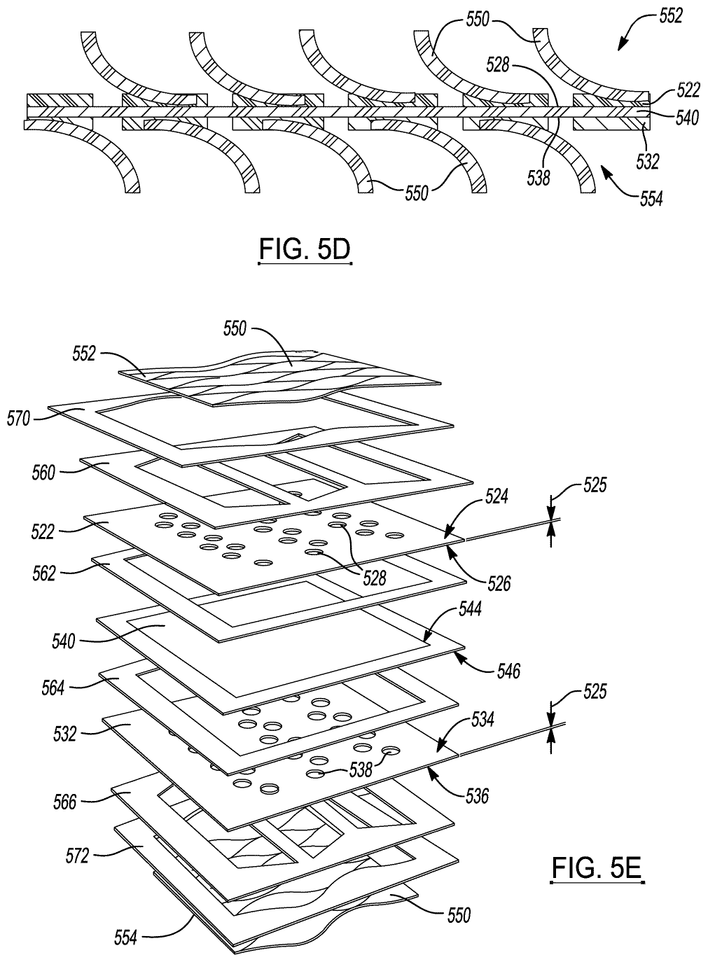

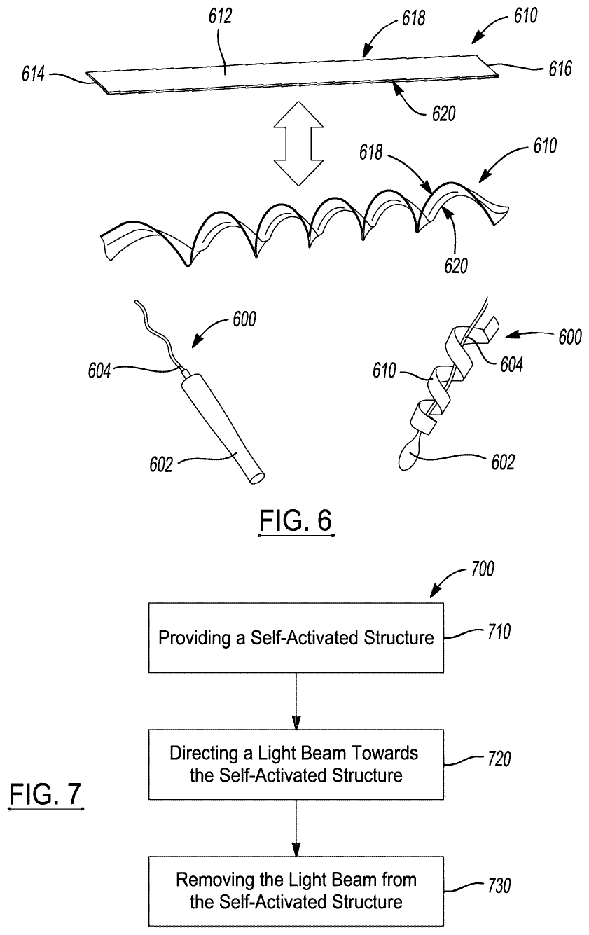

The self-activated structures 10 of FIGS. 1 and 110 of FIG. 2 may be incorporated into a variety of applications. For example, the self-activated structures 10 and 110 may be incorporated into an actuator such as a shutter for a building structure (FIGS. 3 and 4), a membrane (e.g., for drug delivery applications, adsorption systems and/or fluid flow systems) (FIG. 5), and/or as an actuator to propel a robot (FIG. 6).

Referring to FIG. 3A-3B, an actuator or shutter 300 (e.g., a micro-shutter) including at least one self-activated structure 310 (also referred to as the “bending structure 310”) is depicted. The shutter includes a first surface 302 and a second surface 304 opposite the first surface 302. The self-activated structure 310 may be the same as or similar to the self-activated structure 110 of FIGS. 2A-2E except as otherwise described below. The shutter 300 includes a ring 312 defining an outer diameter 314, an inner diameter 316, and a center 318. The ring 312 defines a first plane 319 (FIGS. 3A(ii) and 3B(ii)).

A first or fixed end 320 of the self-activated structure 310 is positioned proximate to the inner diameter 316 of the ring 312. The fixed end 320 has a curved shape and extends between a first intersecting point 322 and a second intersecting point 324. A second end 326 and a third end 328 (the “movable ends 326, 328”) extend radially inward from the fixed end 320. The movable ends 326, 328 are joined at a third intersecting point 330 proximate to the center 318 of the ring 312. Each of the movable ends 326, 328 have a generally curved shape.

In one example embodiment, the shutter 300 includes six self-activated structures 310 each extending radially inward from the inner diameter 316 of the ring 312. Each of the self-activated structures 310 includes a base layer (see, e.g., base layer 12 of FIG. 1) positioned proximate to the first surface 302, a temperature sensing layer (see, e.g., temperature sensing layer 14 of FIG. 1) positioned proximate to the second surface 304, and an interface layer (see, e.g., interface layer 16 of FIG. 1) disposed between the base layer and the temperature sensing layer. It is contemplated that in other examples, the shutter 300 includes any number of self-activated structures 310, such as more or less than six self-activated structures 310.

The shutter 300 is reversibly movable as a function of light between a first or closed position (FIG. 3A) and a second or open position (FIG. 3B). In other words, when light (e.g., a beam of artificial and/or ambient light) is directed to the first surface 302 of the shutter 300, each of the self-activated structures 310 cooperate to move from a deactivated position oriented parallel to the plane 319 of the ring 312 to an activated position at an angle relative to the plane 319 of the ring 312. In the closed position, each of the third intersecting points 330 are positioned adjacent to each other at the center 318 of the ring, preventing light from passing through the shutter 300. In the open position, due to the self-activation of each of the self-activated structures 310 in response to light, each of the third intersecting points 330 are spaced apart from each other thereby forming an opening at the center 318 of the ring 312. In the open position, light passes through the shutter 300 via the opening.

With reference to FIG. 4, in one example embodiment, a building structure 400 includes a plurality of shutters 300. The building structure 400 may be a window, a wall, or a roof, by way of non-limiting example. The shutters 300 are self-activating in response to light 410 (e.g., sunlight). In this way, the shutters 300 are configured to reversibly prevent and permit light to be transmitted through the building structure 400 (e.g., through a window) without an operator manually opening and closing the shutters or other conventional structures such as window blinds. For example, in response to sunlight, the shutters 300 move into an open position (A) thereby permitting sunlight to stream through the building structure 400. When the sunlight is no longer directed to the shutters 300, the shutters move into the closed position (B) thereby restricting visibility through the building structure 400. The building structure 400 including self-activated shutters 300 may improve energy efficiency as compared to a building structure that is free of self-activated shutters.

In an alternate example, the building structure 400 includes a plurality of shutters 300 that are reversibly movable as a function of light between an first or open position (see, e.g., the open position of FIG. 3B) to a second or closed position (see, e.g., the closed position of FIG. 3A). In other words, when light is directed to each of the shutters 300, the self-activated structures 310 move from the open position to the closed position. When light is removed from the shutters 300, the shutters move back to the open position. In this way, the shutters 300 may improve energy efficiency by restricting heat dissipation into the building when exposed to sunlight as compared to a building structure that is free of self-activated shutters.

Referring to FIGS. 5A-C, another actuator 500 including at least one self-activated structure is depicted. The actuator 500 includes a membrane 502 extending between a first surface 504 and a second surface 506 opposite the first surface 504. The membrane 502 includes a plurality of pores or channels 508 extending therethrough. A delivery unit (not shown), such as a drug, growth factor, therapeutic agent, molecule, cell, etc., is disposed in all or a portion of the pores 508. In one example embodiment, the actuator 500 is configured to release the delivery units to a target. It is advantageous to control the release of the delivery units via self-activation characteristics of the actuator 500.

The actuator 500 further includes at least one self-activated structure 510 (also referred to as the “bending structure 510”) disposed on one or both of the surfaces 504, 506. In the example shown in FIG. 5C, at least one self-activated structure 510 is disposed on both the first surface 504 and the second surface 506. The self-activated structure 510 may be the same as or similar to the self-activated structure 110 of FIGS. 2A-B or 310 of FIGS. 3A-3B except as otherwise described below. In the example of FIG. 5, the at least one self-activated structure 510 includes a plurality of self-activated structures 510 that are substantially aligned with each of the plurality of pores 508 on the first surface 504 of the membrane 502. Any number of self-activated structures 510 corresponding to any number of pores 508 may be utilized. It is contemplated that the self-activated structures 510 may define a variety of shapes, such as generally triangular, hexagonal, circular, and/or rectangular shapes, by way of non-limiting example. In the example of FIG. 5C, the self-activated structures 510 have a generally triangular shape. In the example of FIGS. 5A-5B, the self-activated structures 510′ have a generally hexagonal shape. The shape, size, of the self-activated structures 510, 510′ may be tailored to achieve the desired drug-delivery characteristics of the actuator 500.

The self-activated structure 510, 510′ is reversibly movable as a function of light between a first or deactivated position (see, e.g., FIG. 5B) and a second or activated position (see, e.g. FIG. 5A). When light is directed to one of the self-activated structures 510, 510′ the self-activated structure 510, 510′ moves to the activated position (FIGS. 5A and 5C) and the delivery unit is released from its respective pore 508. When light is not directed to the self-activated structure 510, the self-activated structure 510 is in the deactivated position (FIG. 5B), thus closing or sealing the respective pore 508. When the self-activated structure 510 is in the deactivated position, the delivery unit is prevented from exiting the membrane 502. In this way, the actuator 500 selectively opens and closes pores 508 of the membrane 502 via the self-activated structures 510 to selectively release delivery units to a target. By locally directing a light source to the desired area or portion of the actuator 500, a user may control the release of the delivery units.

In another example embodiment, an actuator 500 including at least one self-activated structure 510 is utilized in an adsorption and/or fluid flow system. The actuator 500 includes a plurality of pore and/or channels 508 in selective communication with a fluid, such as a liquid (e.g., a liquid solvent) and/or a gas. For example, in a first or closed position (FIG. 5B), the actuator 500 may separate the fluid positioned on a first side 504 of the membrane 502 from a sorbent (not shown) positioned on a second side 506 of the membrane 502 such that the fluid is prevented from passing through the channels 508. When light is directed to one or more of the self-activated structures 510, the self-activated structures 510 move into a second or open position (FIG. 5A), permitting fluid to flow through the channels 508. By locally directing a light source to the desired area or portion of the actuator 500, a user may control the fluid flowing through the channels. In this way, the actuator 500 may be activated artificially and/or via ambient light (e.g., open during the day and closed during the night) on a cycle to subject the sorbent to regeneration conditions.

Referring to FIGS. 5D-5E, in another example embodiment, another actuator or smart membrane system 520 is depicted. The smart membrane system 520 may be configured to selectively permit a fluid (e.g., gas (e.g., CO₂), and/or liquid) to flow therethrough. The smart membrane system 520 includes a first membrane 522 extending between a first surface 524 and a second surface 526 opposite the first surface 524. The first membrane 522 includes a first plurality of pores or channels 528 extending therethrough. The smart membrane system 520 further includes a second membrane 532 extending between a first surface 534 and a second surface 536 opposite the first surface 534. The second membrane 534 includes a second plurality of pores or channels 538 extending therethrough. Each of the first and second membranes 522, 532 is comprised of a polymer, although other membrane materials are contemplated. For example, the membranes 522, 532 may selected from the group consisting of: poly (methyl methacrylate) (PMMA), polycarbonate (PC), polytetrafluoroethylene (PTFE), polyvinylidene fluoride (PVDF), ethylene tetrafluoroethylene (ETFE), co-polymers thereof, and combinations thereof.

Each of the membranes 522, 532 has a thickness 525 (FIG. 5E) that is greater than 0 mm (e.g., greater than or equal to about 1.5 mm, greater than or equal to about 2 mm, greater than or equal to about 2.5 mm, greater than or equal to about 3 mm, greater than or equal to about 3.5 mm, greater than or equal to about 4 mm, greater than or equal to about 4.5 mm, or greater than or equal to about 5 mm, greater than or equal to about 5.5 mm, greater than or equal to about 6 mm, greater than or equal to about 6.5 mm, greater than or equal to about 7 mm, greater than or equal to about 7.5 mm, greater than or equal to about 8 mm, greater than or equal to about 8.5 mm, greater than or equal to about 9 mm, greater than or equal to about 9.5 mm, greater than or equal to about 10 mm, greater than or equal to about 25 mm, greater than or equal to about 50 mm, greater than or equal to about 75 mm, or greater than or equal to about 100 mm). Preferably, the thickness 525 is greater than or equal to about 2 mm to less than or equal to about 10 mm. More narrowly, the thickness 525 is greater than or equal to about 2 mm to less than or equal to about 4 mm. A velocity of the fluid flowing through each of the pores 528, 538 may be tailored by the thickness 525. The thickness 525 may also be tailored to achieve desired structural characteristics of the smart membrane system 520 (e.g., strength, stiffness, hardness, etc.). In one example, the first membrane 522 includes 18 pores 528, the thickness 525 is about 2.5 mm, a flowrate of the fluid flowing through each of the pores 528 ranges from about 10⁰ to 10⁴ mL/min.

The smart membrane system 520 further includes at least one permeable membrane 540 extending between a first surface 544 and a second surface 546 opposite the first surface 544. The permeable membrane 540 comprises graphene. In the example of FIGS. 5D-5E, the permeable membrane 540 comprises graphene oxide. The permeable membrane 540 is configured to selectively permit certain gasses to pass therethrough. For example, the permeable membrane 540 may be a porous membrane having pore dimensions corresponding to a size of a fluid particle. In this way, the permeable membrane 540 is configured to separate certain fluids based on fluid particle size. The permeable membrane 540 of FIGS. 5D-5E is configured to permit CO₂ gas to pass therethrough.

The smart membrane system 520 further includes at least one self-activated structure 550 (also referred to as the “bending structure 550”). In the example of FIGS. 5D-5E, the self-activated structure 550 includes a first plurality of self-activated structures 550 arranged in a first self-activated layer 552 and a second plurality of self-activated structures 550 arranged in a second self-activated layer 554. The self-activated structures 550 may be the same as or similar to the self-activated structures 510 of FIG. 5C.

The smart membrane system 520 includes the permeable membrane 540, the first membrane 522, the second membrane 532, the first self-activated layer 552, and the second self-activated layer 554 arranged in a sandwich structure. The permeable membrane 554 is disposed between the first membrane 522 and the second membrane 532 such that the second surface 526 of the first membrane 522 is disposed on the first surface 544 of the permeable membrane 540 and the first surface 534 of the second membrane 532 is disposed on the second surface 546 of the permeable membrane 540. The first self-activated layer 552 is disposed on the first surface 524 of the first membrane 522. The second self-activated layer 554 is disposed on the second surface 536 of the second membrane 532.

The smart membrane system 520 includes one or more adhesive layers. For example, the smart membrane system 520 includes a first adhesive layer 560 disposed between the fist self-activated layer 552 and the first membrane 522, a second adhesive layer 562 disposed between the first membrane 522 and the permeable membrane 540, a third adhesive layer 564 disposed between the permeable membrane 540 and the second membrane 532, and a fourth adhesive layer 566 disposed between the second membrane 532 and the second self-activated structure 554. The first, second, third, and fourth adhesive layers 560, 562, 564, and 566 may be pressure sensitive adhesive layers.

The smart membrane system 520 may include one or more additional layers (e.g., structural or supporting layers). A first supporting layer 570 is disposed between the first self-activated layer 552 and the first adhesive layer 560. A second supporting layer 572 is disposed between the second self-activated layer 554 and the fourth adhesive layer 566.

In the example of FIGS. 5D-5E, each the self-activated structures 550 are substantially aligned with each of the plurality of channels 528, 538. More specifically, each of the self-activated structures 550 of the first self-activated layer 552 are aligned with the first plurality of channels 528 of the first membrane. Likewise, each of the self-activated structures 550 of the second self-activated layer 554 are aligned with the second plurality of channels 538 of the second membrane 532. Any number of self-activated structures 550 corresponding to any number of channels 528, 538 may be utilized.

The self-activated structures 550 are reversibly movable as a function of light between a first or deactivated position (see, e.g. FIG. 5B) and a second or activated position (see, e.g., FIGS. 5A, 5D, and 5E). When light is directed to one or more of the self-activated structures 550, the self-activated structure 550 moves to the activated, or open, position. When the self-activated structure 550 is in the open position, fluid is permitted to flow through the channels 528, 538. Conversely, when light is removed from one or more of the self-activated structures 550, the self-activated structure moves to the deactivated, or closed, position. When the self-activated structure 550 is in the closed position, fluid is prevented from flowing through the channels 528, 538. By locally directing a light source to the desired area or portion of the smart membrane system 520, a user may control the fluid (e.g., the amount and/or type of fluid) flowing through the channels 528, 538. Moreover, by tailoring the permeable membrane 540 (e.g., by tailoring the material selection, geometry, and/or pore size and configuration), fluid may be separated by size to selectively permit fluid to flow through the channels 528, 538.

Referring to FIG. 6, an actuator for a robot 600 (e.g., a soft robot) including a self-activated structure 610 (also referred to as the “bending structure 610”) is depicted. In one example embodiment, the robot 600 includes a base 602 and a leg 604 extending axially from the base 602.

The self-activated structure 610 may be the same as or similar to the self-activated structure 10 of FIG. 1 except as otherwise described below. The self-activated structure 610 includes a body 612 extending between a first end 614 and a second end 616. The body 612 includes a first surface 618 and a second surface 620 opposite the first surface 818. The self-activated structure 610 is wrapped in a coil around at least a portion of the leg 604 of the robot 600. Put another way, at least a portion of the leg 604 extends through the coiled self-activated structure 610 such that the second surface 620 of the self-activated structure 610 is proximate to but spaced apart from the leg 604.

The self-activated structure 610 is reversibly movable as a function of light. For example, the self-activated structure 610 is movable between a first or deactivated position and a second or activated position. When light is directed to the first surface 618 of the self-activated structure 610, the self-activated structure 610 moves to the activated position. In the activated position, the self-activated structure 610 may be contracted such that the coil is wound tighter around the leg 604 of the robot as compared to the deactivated position. By selectively activating the self-activated structure 610 between the activated and deactivated positions, for example by selectively directing a light to the self-activated structure 610, the movement of the self-activated structure 610 will drive movement of the robot 600. In other words, selectively activating the self-activated structure 610 propels the robot 600. It is contemplated that the movement of the self-activated structure 610 is controlled remotely. In this way, a robot 600 including a self-activated structure 610 may be self-actuated and configured move or propel the robot 600 inside of a subject.

FIG. 7 illustrates a method 700 of opening an actuator according to various principles of the present disclosure. The method 700 includes providing a self-activated structure at 710. In one example, the providing includes providing an actuator including at least one self-activated structure. The self-activated structure includes a base layer, a temperature sensing layer, and an interface layer disposed between the base layer and the temperature sensing layer. The base layer includes a transparent elastomer. The temperature sensing layer includes a conductive metal. The interface layer includes a graphene nanolayer. In one example embodiment, the base layer is PDMS and the temperature sensing layer is aluminum. The self-activated structure alters its shape reversibly as a function of light.

The method 700 further includes directing a beam from a light source towards the base layer at 720. The light source may include visible light, IR light, ambient sunlight, or combinations thereof. The light source may include artificial light at an intensity of greater than or equal to about 100 W/m² to less than or equal to about 1000 W/m². Additionally or alternately, the light source may include ambient sunlight at an intensity of greater than or equal to about 1000 W/m². The method may optionally include removing the beam of light from the self-activated structure at 730.

For proof of concept, a self-activated structure (i.e., a bending structure) in accordance with the present disclosure was fabricated and tested. The self-activated structure may be fabricated in an inactive state (e.g., under ambient light that is less than 50 W/m²) or in an active state (i.e., pre-constrained state) (e.g., under ambient light that is greater than 750 W/m²).

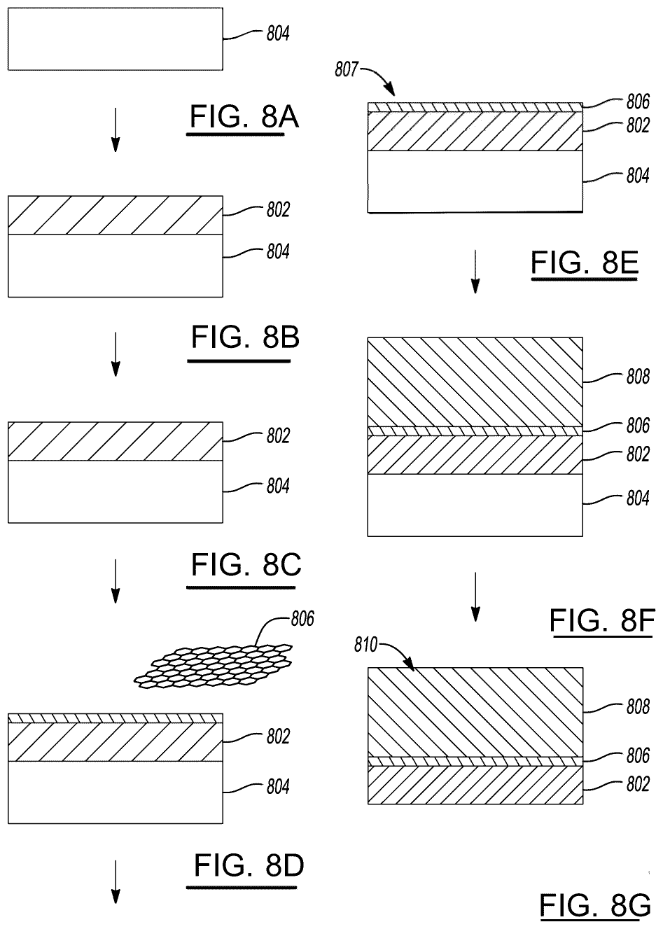

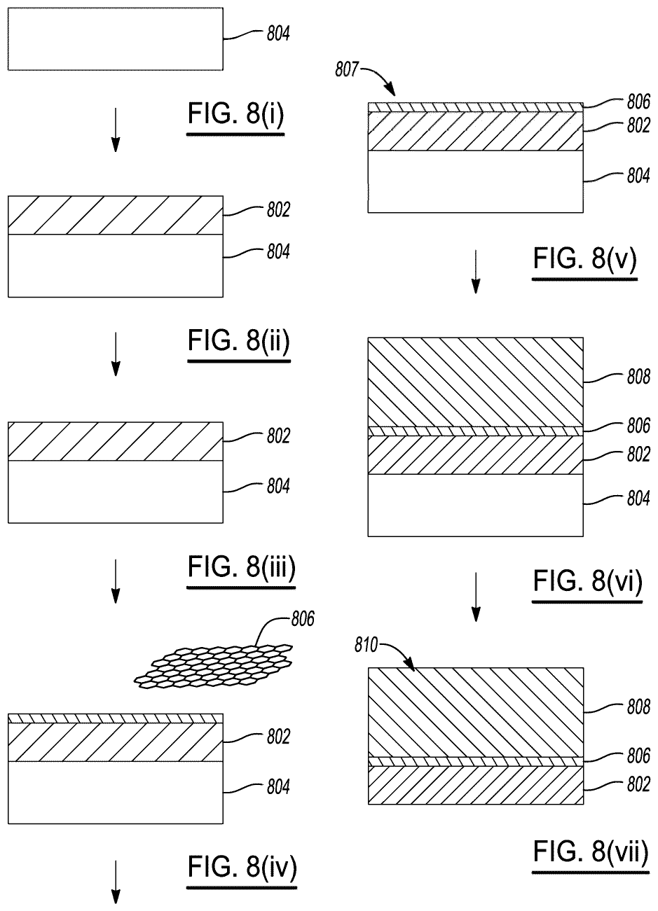

FIG. 8 depicts a method of fabricating a self-activated structure 810 (also referred to as the “bending structure 810”). In FIGS. 8A and 8B, fabrication begins with depositing an elastomer 802 onto a substrate 804. The elastomer 802 is a B-stage PDMS at a 12:1 elastomer to curing agent ratio. The substrate 804 is a glass substrate. In FIG. 8C, a low temperature curing process follows to ensure a strong π-π interaction between a graphene layer 806 and the PDMS layer 804. Strong π-π interactions between the graphene layer 806 and the PDMS layer 802 are provided by the compatibility of the aromatic ring structure of graphene and B-stage PDMS. This leads to strong bonds at the interface and enables a self-activated structure having reduced or eliminated delamination issues. The PDMS layer 802 is incubated overnight.

Next, in FIG. 8D the graphene layer 806 is deposited on the PDMS layer 802. In FIG. 8E the graphene/PDMS sub-structure 807 is treated via a heat treatment at a temperature of 100° C. for about 30 minutes.

The graphene layer 806 is a purified graphene sheet. The graphene layer 806 has a uniform structure. Prior to the fabrication, the structure of the graphene sheet is confirmed by Raman spectroscopy. The Raman signal is acquired using an Olympus 1×73 outfitted with a spectrograph monochromator and a CCD. Samples of the graphene sheet are placed on a heating stage (THMS600) with controlled temperature for a temperature-dependent Raman measurement. A focused 532 nm laser with less than 90 mW of power is used for the measurement. At this power, the laser-induced temperature increase is typically limited to about 20° C. The laser is operated at 2 mW and 532 nm using a 50× objective lens with a NA of 0.7. Each acquisition takes about 1 second. Preprocessing is done on the signals to lower noise, fix baselines, and get rid of data spikes. The negative thermal expansion of the graphene sheet as a function of temperature is also confirmed.

Next, in FIG. 8F a metal layer 808 is deposited onto the graphene layer 802. Suitable methods of deposition may include physical vapor deposition (PVD) (e.g., evaporation), sputtering, atomic layer deposition, etc. Prior to depositing the metal layer 808, the sub-structure 807 is taped onto the substrate 804 using a Kapton tape. The sub-structure 807 is then loaded into an E-beam evaporator. A layer of titanium having a thickness of about 2 nm and a layer of aluminum having a thickness of about 500 nm are deposited at a rate of 0.5 nm/sec. During deposition, the sub-structure 807 is placed above the sources at a constant rotating speed of 100 rpm. The titanium layer enhances adhesion between the PDMS layer 802, graphene layer 806, and aluminum layer 808 and reduces delamination of the structure during release of residual stress.

Finally, in FIG. 8G the substrate 804 is removed to form the self-activated structure 810. The substrate 804 is removed by detaching the Kapton tape. Optionally, the self-activated structure 810 is cleaned via ultrasonic treatment in DI water.

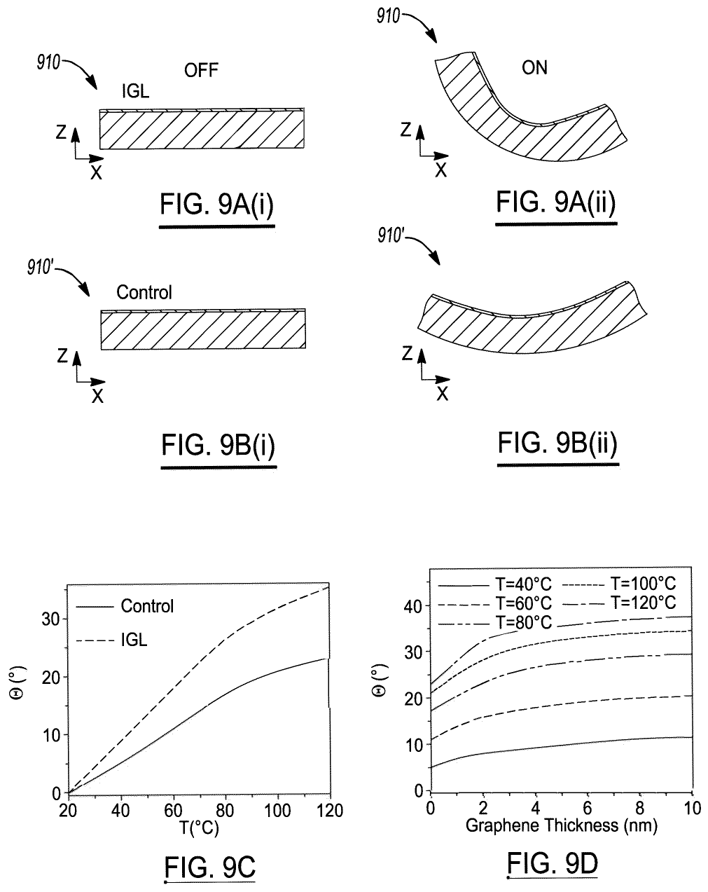

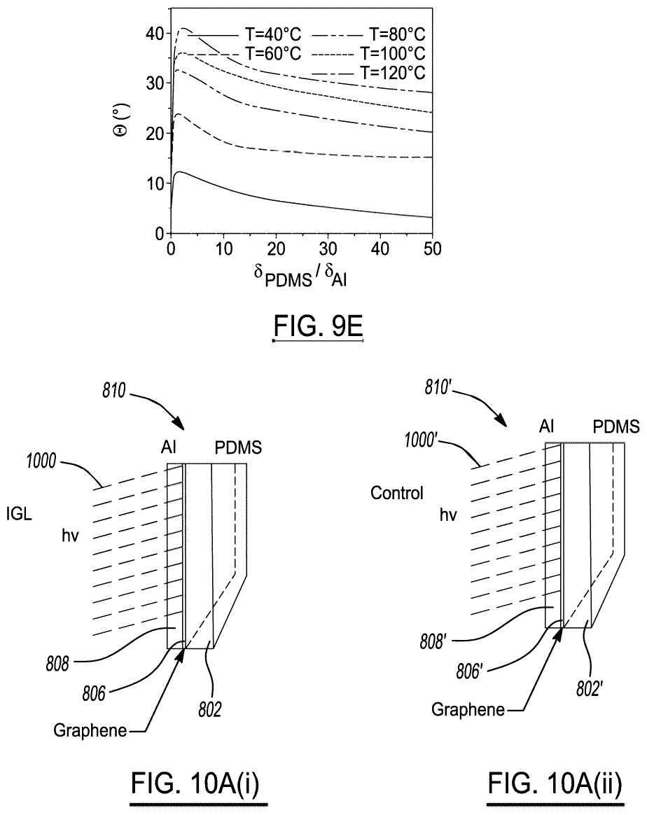

First, as shown in FIG. 9A-9E, to theoretically confirm the effect of negative thermal expansion on temperature sensitive self-actuation, a Multiphysics finite element analysis (FEA) is used to investigate the self-actuation of a self-activated structure 910. In the FEA, a fixed support boundary is applied to an edge of a PDMS layer. All surfaces in contact with air were subjected to free convection condition (including the top part of an aluminum layer). A thickness (δ) of a graphene layer is one hundred times less than a thickness of the PDMS layer and aluminum layer (i.e., δ_{G}/δ_{PDMS}=0.001). Thus, a temperature gradient within the graphene layer is negligible compared to that in the PDMS layer and aluminum layer. The self-activated structure 910 is moveable between a first position at a relatively low temperature (FIG. 9A(i)) and a second position at a relatively high temperature (FIG. 9A(ii)) due to the negative thermal expansion coefficient of graphene.

Mechanical thermal characteristics of the self-activated structure 910 are compared to a control structure 910′ that is free of a graphene layer (i.e., the control structure 910′ consists essentially of a PDMS layer and an aluminum layer). While control structure 910′ is also movable between a first position at the relatively low temperature (FIG. 9A(iii)) and a second position at the relatively high temperature (FIG. 9A(iv)), as shown in FIG. 9B, the self-activated structure 910 including the graphene layer 906 has a greater difference in shape (i.e., a larger contraction or deflection) when activated. At a temperature of 75° C., the self-activated bending angle of the self-activated structure 910 (FIG. 9B(ii)) is greater than the control structure 910′ (FIG. 9B(iv)). Specifically, the bending angle of the self-activated structure 910 is about 20 degrees in 30 seconds while the bending angle of the control structure 910′ is only about 10. The control structure 910′ generally exhibits slower bending as compared to the self-activated structure 910. When the environmental temperature returns to room temperature (FIGS. 9B(i) and 9B(iii), the self-activated structure 910 and control structure 910′ return to their initial geometries with a similar time response. Thus, the self-activation mechanism of the self-activated structure 910 consistently responds to temperature.

FIG. 9C shows the self-activated bending angle of the self-activated structure 910 and control structure 910′ as a function of temperature (° C.) from 25 to 100° C. when the thickness ratio of the graphene layer to PDMS layer (δ_{Graphene}/δ_{PDMS}) is about 0.001 and the thickness ratio of the (δ_{PDMS}/δ_{Aluminum}) is about 10. The self-activated structure 910 including the graphene layer exhibits twice as large of a bending angle as compared to the control structure 910′ that is free of a graphene layer. At a temperature of about 30° C., the bending angle of self-activated structure 910 is about 15 degrees. At a temperature of about 100° C., the bending angle is about 50 degrees. This indicates that the self-activated structure 910 exhibits a higher degree of bending at higher temperatures. In other words, the self-activation mechanism of the self-activated structure 910 enables temperature sensitive activation.

FIG. 9D shows the self-activated bending angle of the self-activated structure 910 as a function of the thickness of the graphene layer at varied temperatures. The bending angle increases as the thickness of the graphene layer increases. However, the bending angle approaches a steady state at a thickness of greater than or equal to about 5 nanometers (nm).

FIG. 9E shows the self-activated bending angle of the self-activated structure 910 as a function of the thickness ratio between the PDMS layer and the aluminum layer when the thickness of the graphene layer is about 5 nm. The thickness ratio between the PDMS layer and the aluminum layer (δ_{PDMS}/δ_{AI}) affects the strain. A maximum bending angle is observed at a thickness ratio of about 1.5.

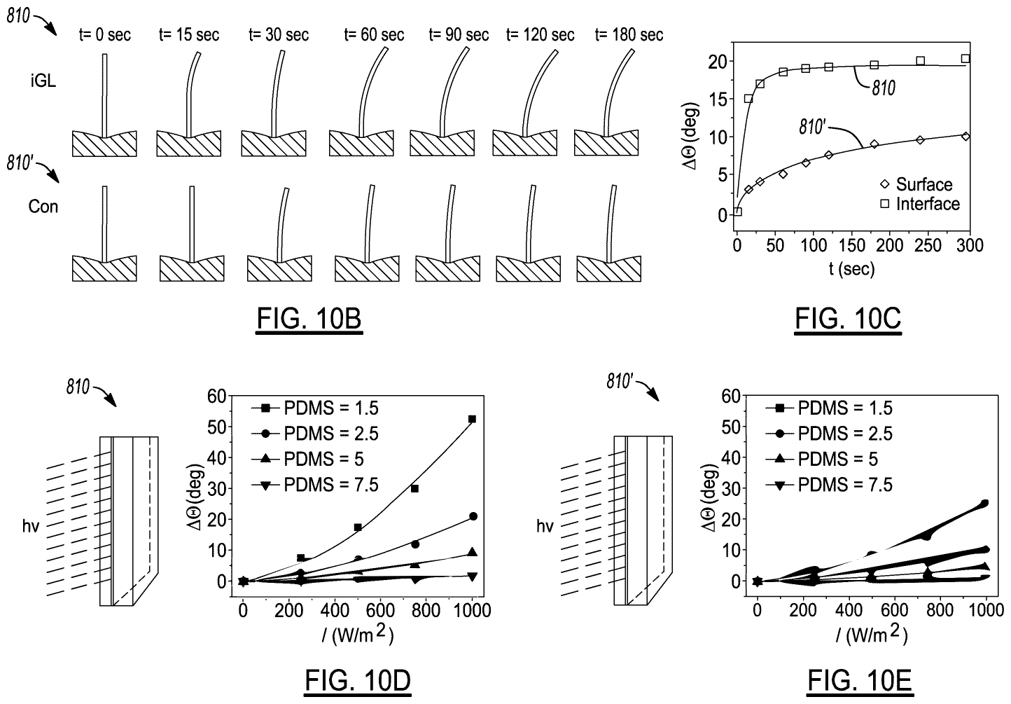

With renewed reference to FIG. 8 and reference to FIG. 10, the mechanical and photothermal characteristics of the self-activated structure 810 are tested. A control structure 810′ including a PDMS layer 802′, an aluminum layer 808′ and a graphene layer 806′ is prepared. Unlike the graphene layer 806 of self-activated structure 810 disposed between the PDMS layer 802 and the aluminum layer 808 (FIG. 10A(i)), the graphene layer 806′ of control structure 810′ is disposed on a surface of the aluminum layer 808′ opposite the PDMS layer 802′ (FIG. 10A(ii)). In other words, the aluminum layer 808′ of the control structure is disposed between the graphene layer 806′ and the PDMS layer 802′.

During testing, the self-activated structure 810 and the control structure 810′ are free hanged. To secure the structures 810, 810′, a fixed boundary with a hold length of 2 millimeters (mm) is used to prevent the released structure from deforming elastically. The unreleased region of the structure remains securely attached to the substrate layer. The structures 810, 810′ are adhered to a glass substrate using medical-grade double-sided tape. A temperature controlled chamber is also constructed. A temperature sensor (K-type thermocouple) is placed in the middle of the chamber to measure the temperature inside the chamber. A proportional-integral-derivative (PID) controller is attached to the thermocouple and the chamber to regulate the temperature. The temperature is monitored using a remotely linked temperature sensor display to ensure that the temperature chamber is stable. The structures 810, 810′ are loaded into the chamber. A metal-oxide semiconductor camera is used to capture photos of the structures 810, 810′. Strain variations and speed at various temperature conditions are measured using the photos. To test photo-actuation, visible light from an overhead lamp is directed to the structures 810, 810′. The lamp is a DolanJenner Fiber-Lite 180 with a 150W, 21 V halogen (EKE) lamp. Photo images of the structures 810, 810′ exposed to light are taken from a CMOS camera.

The self-activation of the self-activated structure 810 is induced by light. That is, the interfacial graphene layer 806 on the aluminum layer 808 leads to efficient photothermal effect. As shown in FIGS. 10A, white light 1000 is directed to the self-activated structure 810 and control structure 810′, respectively, at ambient temperature. As shown in FIG. 10B-10C, after 180 seconds of exposure to light, the shape of both the self-activated structure 810 and the control structure 810′ are altered. Notably, the self-activated structure 810 results in maximum actuation in 5 seconds (a bending angle of about 25 degrees) while the control structure 810′ results in a bending angle of about 5 degrees in 20 seconds. The self-activated structure 810 including the graphene layer 806 disposed between the PDMS layer 802 and aluminum layer 808 exhibits twice larger bending angle and three times faster photo-activation as compared to the control structure 810′.

Because the PDMS layer 802 is transparent (i.e., has a transmission of about 100%), light is directly absorbed by the graphene layer 806 and aluminum layer 808. In this way, self-activation of the self-activated structure 810 may be achieved without the self-shading effect. As shown in FIG. 10D, the bending angle of the self-activated structure 810 is shown as a function of light intensity (W/m²) at different δ_{Graphene}/δ_{PDMS} measurements. Across all δ_{Graphene}/δ_{PDMS} measurements, the bending angle increases in response to increased light intensity. Notably, when δ_{Graphene}/δ_{PDMS}=0.001 and the light is directed at an intensity of 250 W/m², the self-activated structure 810 reaches a bending angle of about 19 degrees within 5 seconds. At an intensity of 1000 W/m², a maximum bending angle of about 55 degrees is achieved. In contrast, at an intensity of 1000 W/m² the control structure 810′ (FIG. 10E) only has a bending angle of about 26 degrees. The maximum bending angle of the control structure 810′ was about 50% less than the bending angle of the self-activated structure 810 at the same condition. The photo-actuation and negative thermal expansion of the graphene layer 806 disposed between the PDMS layer 802 and aluminum layer 808 as a function of light leads to significantly enhanced and rapid self-activating performance of the self-activated structure 810.

A self-activated micro-shutter is fabricated and tested including six self-activated structures 810. The micro-shutter may be the same as or similar to the shutter 300 of FIGS. 3A-3B. Each of the self-activated structures 810 exhibits asymmetric motion in response to temperature change and/or light illumination. The assembly of the six self-activated structures 810 allows for harmonic, consistent, and mechanically stable shutting motion in 3D.

First, FEA analysis is performed on a model of the shutter assembly. The asymmetric bending structure pattern along y-axis at edge of x-axis leads to 3D motion, while the symmetric bending structure pattern at the center of x-axis results in motion only on y-z plane. The relative distance of bending structure pattern is systemically engineered from the centerline in the single unit geometry to maximize the 3D motion and mechanical strength by performing FEA.

The micro-shutter is fabricated by i) fabricating a first layer including the sub-structure 807 consisting of 2D patterned array of the PDMS layer 802 and graphene layer 806, ii) integrating a hook shaped edge pattern on the first layer, iii) placing the six fabricated first layers on the spherical shaped substrate, iv) depositing an asymmetric aluminum pattern on the sub-structures 807 to form aluminum layers 808, and v) assembling of the top and bottom supporting layers. The thickness ratio for each of the self-activated structures of the micro-shutter is δ_{G}/δ_{PDMS}=0.001.

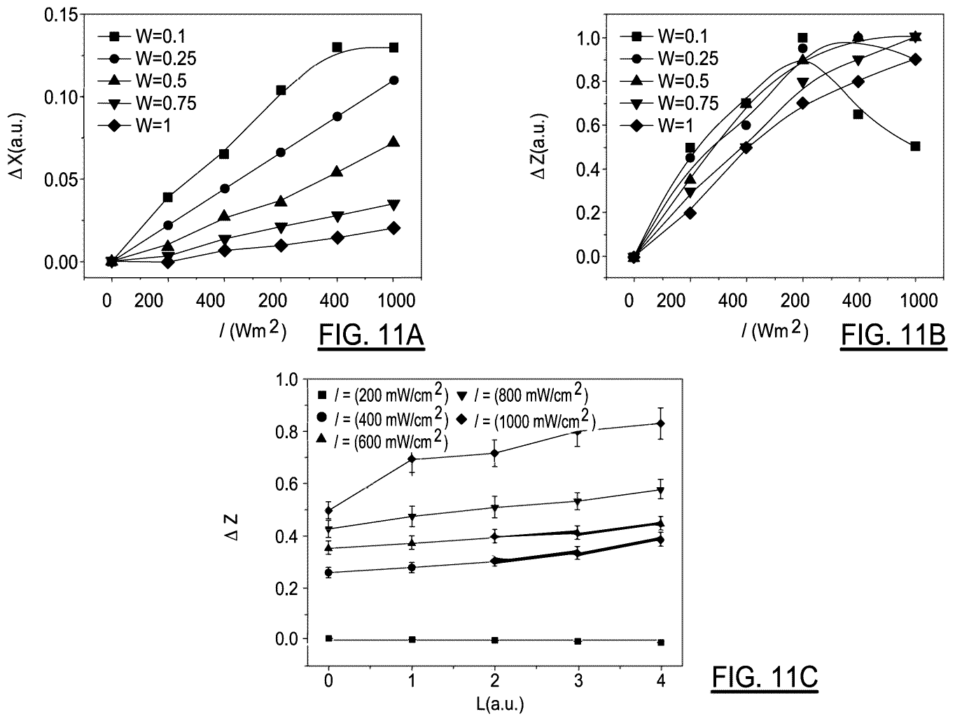

As shown in FIG. 11A-11C, the self-activated open/close of the micro-shutter structure is tested under a light intensity (/) of about 0 to 1,000 W/m². The dimensional change of the micro-shutter in the X direction (FIG. 11A), the Z direction (FIG. 11B) are measured. At an intensity of about 250 W/m² in ambient air, the micro-shutter structure opens with 100% open/close ratio (Rₒ=opened angle/90°×100%) in 30 seconds. When the intensity is switched to 0 W/m², the micro-shutter closes with Ro =0% in 30 seconds. The rate of opening and closing the micro-shutter structure exhibits the trends of the single self-activated structure observed in FIGS. 10A-10E. This indicates that the self-actuation mechanism in the micro-shutter works without any structural interference that can affect the actuation performance.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A bending structure, comprising:
a base layer comprised of a transparent elastomer;
an interface layer disposed on the base layer, wherein the interface layer is comprised of graphene; and
a temperature sensing layer disposed on the interface layer and comprised of a metal,
wherein the bending structure alters its shape reversibly as a function of light.

2. The bending structure of claim 1, wherein the base layer is selected from the group consisting of: polydimethylsiloxane, polyaniline, polypyrrole, polythiophene, polystyrene, polyphenylene-vinylene, polyphenylenesulfide, polyacetylene, polyfluorene, co-polymers thereof, and combinations thereof.

3. The bending structure of claim 1, wherein the temperature sensing layer is selected from the group consisting of: aluminum, gold, copper, alloys thereof, and combinations thereof.

4. The bending structure of claim 1, wherein the light is visible light.

5. The bending structure of claim 1, wherein the base layer has a first thickness, the temperature sensing layer has a second thickness, and wherein a first ratio between the first thickness and the second thickness is greater than or equal to about 0.1 to less than or equal to about 10.

6. The bending structure of claim 5, wherein the interface layer has a third thickness, and wherein a second ratio between the third thickness and the first thickness is about 0.001.

7. A bending structure comprising:
a body extending between a fixed end and at least one movable end, the body comprising:
a base layer comprised of a transparent elastomer;
an interface layer disposed on the base layer, wherein the interface layer is comprised of graphene; and
a temperature sensing layer disposed on the interface layer and comprised of a metal,
wherein:
the bending structure is reversibly movable as a function of light between a first position and a second position,
in the first position, the at least one movable end is positioned at a first angle relative to the fixed end,
in the second position, the at least one movable end is positioned at a second angle relative to the fixed end, and
the second angle is greater than the first angle.

8. The bending structure of claim 7, wherein:
the base layer is selected from the group consisting of:
polydimethylsiloxane, polyaniline, polypyrrole, polythiophene, polystyrene, polyphenylene-vinylene, polyphenylenesulfide, polyacetylene, polyfluorene, co-polymers thereof, and combinations thereof, and
the temperature sensing layer is selected from the group consisting of: aluminum, gold, copper, alloys thereof, and combinations thereof.

9. The bending structure of claim 7, wherein the body has a generally triangular shape.

10. The bending structure of claim 7, wherein the at least one movable end has a generally curved shape.

11. An actuator comprising:
a ring; and
at least one bending structure of claim 7 extending radially inward from the ring.

12. The actuator of claim 11, wherein the ring defines an outer diameter, an inner diameter, and a center, and wherein the fixed end of the bending structure is positioned proximate to the inner diameter of the ring and the at least one movable end of the bending structure extends radially inward toward the center of the ring.

13. The actuator of claim 12, wherein the at least one bending structure includes six bending structures spaced around the inner diameter of the ring.

14. The actuator of claim 13, wherein in the first position, the at least one movable end of each of the bending structures is at the first angle and the shutter is in a closed position.

15. The shutter of claim 14, wherein in the second position, the at least one movable end of each of the bending structures is at the second angle and the shutter is in an open position.

16. An actuator comprising:
a membrane extending between a first surface and a second surface opposite the first surface, the membrane comprising a plurality of pores extending therethrough, and
at least one bending structure of claim 7 disposed on the first surface and positioned proximate to at least one of the plurality of pores.

17. The actuator of claim 16, wherein in the first position, the body of the bending structure covers at least one of the plurality of pores, and wherein in the second position, the body of the bending structure is spaced apart from at least one of the plurality of pores.

18. A robot comprising,
a base;
a leg extending axially from the base; and
a bending structure wrapped in a coil around at least a portion of the leg, the bending structure comprising:
a base layer comprised of a transparent elastomer;
an interface layer disposed on the base layer, wherein the interface layer is comprised of graphene; and
a temperature sensing layer disposed on the interface layer and comprised of a metal,
wherein the bending structure is reversibly movable as a function of light.

19. The robot of claim 18, wherein movement of the bending structure propels the robot.

20. The robot of claim 18, wherein the movement of the bending structure is controlled remotely.
